(19) United States
(12) Patent Application Publication
(10) Pub. No.: US 2005/0144100 A1
(43) Pub. Date: Jun. 30, 2005

(54) Payment systems and methods for earning incentives using at least two financial instruments

(76) Inventors: Craig Shapiro, Creve Coeur, MO (US); Kevin Krafve, Chesterfield, MO (US)

Correspondence Address: Box IP Department;Suite 2000, 500 North Broadway, St. Louis, MO, 63102, US

(21) Appl. No.: 10/748,710

(22) Filed: Dec. 30, 2003

(51) Int. Cl. G06F 17/60

(52) U.S. Cl. 705/35

(57) ABSTRACT

Systems and methods for having a first party pay a second party by incurring a first debt on a loan instrument which earns the first party an incentive. The first debt is then paid off by the first party from a second financial instrument before costs (particularly interest charges) are accrued on the first loan instrument. The systems and methods may be used to provide credit card incentives to construction contractors by having them pay a subcontractor using a credit card providing incentives and then paying off the credit card debt from a line of credit before interest charges accrue on the credit card debt.

### BACKGROUND OF THE INVENTION

1. Field of the Invention

This disclosure relates to the field of payment systems. Particularly, it relates to systems and methods for borrowing funds using a first lending instrument which provides incentives for borrowing funds, and then repaying the borrowed funds using a second instrument (generally a second lending instrument) which has preferable terms to those of the first instrument so as to earn incentives for borrowing while also utilizing a preferable account for debt and without incurring additional costs.

2. Description of the Related Art

In the United States currently, debt is a way of life. Infrastructure is built and financed on borrowed money to achieve growth not obtainable when hard currency must be used. This use of debt has created a variety of fairly specialized debt instruments designed for use with certain types of transactions. Some debt instruments generally offer a relatively low rate of interest in exchange for repayment of the instrument being more heavily secured by assets of the borrower and for the debt to be designed to be used over a long term where payments are made regularly but the debt is rarely paid off in a quick time scale to avoid paying interest. Some of these types of debt instruments include those used in property lending, vehicle loans, or other large purchase financing. These instruments are generally profitable by having a relatively fixed incoming interest value over time and by taking security interests to help insure that they will be repaid providing for a relatively safe investment.

On the other side of the spectrum are short term, relatively unsecured loans. These are generally in the form of consumer credit cards. These cards provide a borrower with essentially free money as they usually require no collateral to obtain and are completely unsecured. In exchange, these loan instruments often have a very high rate of interest and may be geared to facilitate the re-payment primarily of interest (but not principal) to allow the borrower to make purchases they otherwise would not be able to make while still netting the loan provider high interest fees (and turning a short term loan into a relatively long term one). Because these types of loans are risky in that they are unsecured, they are also generally issued for small amounts compared to secured loans. Smaller loan amounts are also common because these types of instruments are principally designed to provide the user with the means to purchase consumer goods as opposed to large items such as real property.

The credit card industry is extremely profitable even with the risks inherent in providing unsecured loans and most purchasing in the United States today is performed on credit cards for ease of transaction. Further, because of profitability and competition between loan providers, many credit cards offer incentive programs where the user can get credits toward the purchase of airline tickets, credits towards merchandise, or cash for simply utilizing the credit card as the method of payment. These types of incentive schemes are particularly prevalent in the credit card industry as a means to distinguish cards from each other and to try to get individuals to utilize one card over another.

For a user who pays off their entire balance before interest rates begin to accumulate on the card, the incentive programs simply provide an incentive to use the card instead of other payment forms or other loan instruments of similar design. The credit card company generally benefits even in these cases. Often the credit card company will charge fees to sellers of goods and services who accept the card (which is a convenient way for users to purchase larger ticket items), and the user may also run an occasional balance. Because of the high interest rates and fees charged, the return will also usually more than compensate for the cost of the incentive as the incentive is often based on 1% of loan value while the fees are regularly over 2% and interest rates may be 20% or more.

It is quite apparent that the incentive is most valuable to the borrower if large charges are made on the credit card and then the card is quickly paid off to avoid incurring interest charges. However, this scheme to enhance the value of the incentive to the borrower is limited in two very important ways. The user can only charge the maximum amount to the credit card they are allowed to charge (which is relatively small) every billing cycle because of the unsecured nature of the loan. Further, the user must have funds available to pay off the entire balance within each month. As the amount borrowed becomes larger, the ability of the user to pay off the entire debt in a timely fashion becomes less and less likely even if they have authority to charge larger amounts.

While a new industry has arisen to consolidate credit card debts together into lower interest generally secured loan instruments (such as home equity loans or other credit cards), these systems typically operate after interest has been charged by the credit card(s). They serve to deal with the problem of later lowering interest rates that are already being charged to facilitate productive payment of the loans. Therefore, the incentive is of little benefit as it has been more than paid for via the interest payments already made.

While loans may be used in all sorts of industries, one of the places where it is quite prevalent is in construction of real property. For instance, if an office building is to be constructed, a contractor will generally make a bid to construct the building. Once their bid is accepted, the contractor will likely obtain a construction loan to finance the construction. Because real property construction often involves significant cost beyond the contractor's personal, or even corporate, ability to finance, funds to pay for the construction generally come from a loan from a bank or other lending institution which are withdrawn by the contractor to pay expenses. In order to secure its investment, the bank generally takes a security interest in the building (or may actually own the building). Further, the bank will generally only release the funds in increments to prevent a contractor from withdrawing all the funds, disappearing, and leaving the bank with little recourse.

Even with secured interests in the building and controlled fund release, the lending institution can still end up in a problematic situation due to systemic delay related to paying construction subcontractors. In particular, there is a delay from the time that work is completed by a subcontractor, until the subcontractor is paid by the contractor. For instance, if a subcontractor completed the work and then took 30 days to send out their invoice which was in turn due 30 days after receipt, the contractor has, at minimum, 60 days from the time the work is completed until the bill has to be paid. Further, the contractor may not pay promptly giving them even more time.

During this time, the contractor can spend the money they have been authorized to use by the lending institution to finance other projects by withdrawing it to “pay” the subcontractor and then using it until the subcontractor is actually paid. There is a clear disincentive for the contractor to pay the subcontractor quickly, because the slower they pay the more funds they have available to fund other projects. As can quickly be seen, with correct application, the contractor can effectively increase his available money by simply always having some of the money he is using being borrowed from another project. Basically, he is using the money he will eventually pay a subcontractor (that has been provided to him by the bank for this purpose), before he has to pay the subcontractor.

This system may not be problematic, so long as no difficulties are encountered in any of the projects and the pattern is consistent. As can be seen, however, if a project runs over budget, or is running slow, suddenly a contractor may be in the situation where he has bills due, but no funds to cover them with. This can place the bank in an awkward situation where they are imperfectly secured through no fault of their own. Because of this type of situation, the bank often does not allow the contractor to have direct access to the loaned money and requires a third party (generally called a title company or other escrow disbursing agent) to handle the payments to subcontractors and withdrawals from the line of credit. Further, the bank may keep careful watch on the actions of the contractor.

This watch by the bank and inclusion of the title company is generally undesirable to the contractor because it can create additional bureaucracy in the transaction, can hamper the contractor, and title companies can charge a fee. Therefore, it is desirable to have a system and method to improve the attractiveness of such an arrangement to the contractor.

### SUMMARY

Because of these and other problems in the art, described herein are systems and methods to allow a first party to maximize incentives earned through the use of a first lending instrument (generally a credit card) which provides an incentive for its use, and minimize the cost of using such a first lending instrument by paying the debt incurred through use of the first lending instrument with the proceeds from a second instrument that has more favorable terms. This system generally allows a first party (usually a construction contractor) to pay a second party (usually a construction subcontractor) using borrowed finds from a first lending instrument (generally an unsecured credit card) which are then paid off from a second financial instrument (generally a secured line of credit) before interest charges are accrued on the first lending instrument. Further, in an embodiment, the unsecured first debt is effectively secured by the funds of the second financial instrument, such security being used as a basis for increasing the value of the debt authorized under the first lending instrument, which authorization would be exceeded without the security of the second instrument to provide for a level of incentives otherwise unattainable to the first party.

Described herein, in an embodiment, there is, amongst other things, a method for a first party to earn an incentive from borrowing, the method comprising: having two sources of borrowed funds, a principal lending instrument having a first level of funds available for secured borrowing and an incentive lending instrument having a second level of funds available for unsecured borrowing, the first level being greater than the second level, and the incentive lending instrument providing an incentive for borrowing; borrowing finds in a first amount from the incentive lending instrument incurring a first debt to the incentive lending instrument; accruing the incentive from the incentive lending instrument; paying the second party with at least a portion of the funds borrowed from the incentive lending instrument; borrowing finds in the first amount from the principal lending instrument incurring a second debt to the principal lending instrument; and crediting the incentive lending instrument with the funds borrowed from the principal lending instrument to eliminate the first debt prior to being charged interest on the first debt.

In an embodiment, the second debt incurs interest charges and interest charged on the first debt would be higher than the interest charged on the second debt if the first debt was not credited prior to the interest being charged.

In an embodiment the first party is a contractor in the construction field and the second party is a subcontractor is the construction field, the incentive lending instrument is a credit card agreement providing for available credit on a credit card such as, but not limited to: American Express, MasterCard, Visa, Diner's Club, Discover, Novus, and/or the principal lending instrument provides for a line of credit, such as, but not limited to that provided by a bank or a construction loan.

In an embodiment the incentive lending instrument includes a payment window from the time borrowing occurs until interest is charged if the first debt remains unpaid.

In another embodiment, the first debt exceeds the second level of funds which debt may be allowed from the incentive lending instrument because the first debt is assured by the first level of funds in the principal lending instrument.

In another embodiment, the first debt and the second debt are of equal value.

In another embodiment, the method may further include any of the steps of: providing a management company to coordinate the relationships among other entities involved in the system, having the management company limit who may participate in the system, and allowing the management company to provide benefits to entities participating in the method possibly wherein in the step of allowing, the management company negotiates discounts with a third party provider for the benefit of at least one of the first party and the second party.

In another embodiment the method may further include the step of: providing a title company which processes the transactions in both the steps of borrowing possibly wherein the title company confirms that the principal lending instrument includes available credit for the first amount prior to the step of borrowing funds in the first amount from the incentive lending instrument or wherein the title company earns interest on the first amount borrowed from the principal lending institution prior to the step of crediting.

In another embodiment, the at least a portion of the funds borrowed from the incentive lending instrument comprises the first amount less a fee, the first party provides at least a portion of the incentive to the second party, or the incentive comprises a number of reward points determined based on the first amount.

In another embodiment, the method is repeatedly performed during a predetermined period of time which may correspond to the time it takes to complete a construction project.

In a still further embodiment, there is described a system for allowing a first party to earn an incentive from borrowing, the system comprising: a first party; a second party who is to be paid by the first party; a principal lending instrument having a first level of funds available for secured borrowing; and an incentive lending instrument having a second level of funds available for unsecured borrowing, the first level being greater than the second level, and the incentive lending instrument providing incentives for borrowing; wherein funds are borrowed in a first amount from the incentive lending instrument incurring a first debt to the incentive lending instrument; wherein the incentives are accrued to the first party from the incentive lending instrument; wherein the second party is paid with at least a portion of the funds borrowed from the incentive lending instrument; wherein funds in the first amount are borrowed from the principal lending instrument incurring a second debt to the principal lending instrument; and wherein the incentive lending instrument is credited with the funds borrowed from the principal lending instrument to eliminate the first debt prior to being charged interest on the first debt.

In still a further embodiment of the system, there may be included a title company through which the funds borrowed from the principal lending instrument pass or the first amount may be greater than the second level and less than the first level.

In yet another embodiment, there is described a system for allowing a first party to earn an incentive from spending, the system comprising: a first party; a second party who is to be paid by the first party; a principal source of funds having a first level of funds available and owned by the first party; an incentive lending instrument having a second level of funds available for unsecured borrowing, the first level being greater than the second level, and the incentive lending instrument providing incentives for borrowing; wherein funds are borrowed in a first amount from the incentive lending instrument incurring a first debt to the incentive lending instrument, the first amount being greater than the second level but less than the first level; wherein a title company withdraws the first amount of funds from the principal source of funds and places the first amount of funds from the principal source of funds in a trust assuring the repayment of the incentive lending instrument; wherein the incentives are accrued to the first party from the incentive lending instrument on the first amount; wherein the second party is paid with at least a portion of the funds borrowed from the incentive lending instrument; and wherein the incentive lending instrument is credited with the funds from the principal source of funds to eliminate the first debt prior to being charged interest on the first debt.

### BRIEF DESCRIPTION OF THE FIGURES

FIG. 1 Provides a flowchart of an embodiment of the steps of a method to utilize an incentive earning system

FIG. 2 Provides a block diagram of the flow of payments within an embodiment of an incentive earning system.

FIG. 3 provides a block diagram of the flow of payments in another embodiment of an incentive earning system.

FIG. 4 provides a detailed diagram focusing on the flow of payments from the incentive lending institution.

FIG. 5 provides a block diagram of the flow of payments within an embodiment including a management company and third-party provider.

FIG. 6 provides a block diagram of the flow of payments in another embodiment of an incentive earning system where a title company's responsibilities are absorbed by the principal lending institution.

### DESCRIPTION OF PREFERRED EMBODIMENT(S)

Disclosed herein, among other things, is a payment system for allowing a first party to get incentive rewards for their credit spending without incurring the additional expenses usually associated therewith and, additionally, to obtain such incentive rewards on credit spending which would exceed the amount of unsecured credit the first party would normally be allowed. Further, the systems and methods generally also allow large loans with lower interest rates to be used to earn incentives generally not offered on such instruments. In a preferred embodiment, the systems and methods are used to allow a construction contractor to obtain American Express or similar consumer credit card reward points for their spending in the construction of a building.

As real property construction often involves significant cost beyond the contractor's ability to finance, funds to pay for the construction generally come from a loan. The contractor obtains funds by borrowing from the bank to pay the expenses of the building's construction. The bank generally takes a security interest in the building (or may actually own the building) to insure repayment. Because of this security interest, the funds lent for the construction will generally have a favorable interest rate and other favorable terms.

For the contractor to pay subcontractors for their work, generally the subcontractor would have to complete the work and provide an invoice to the contractor for the work performed. The invoice would be paid by the contractor by accessing funds made available through the construction loan. While this scheme meets the necessities of the transaction, it is desirable to provide some form of incentive system to a contractor to control their behavior during this process. In particular, most lenders would like an independent third party to monitor payments and to withdraw from the line of credit to prevent abuses by the contractor and late payment to the subcontractor. Providing the contractor with incentive to use such a third party is desirable on the part of the lending institution and the subcontractor.

One of ordinary skill in the art would understand that the payment system and methods discussed herein could be used in any type of business transaction where the final incurred payment is in the form of a debt recorded in a lending instrument or where the initial payment exceeded a pre-authorized unsecured lending amount. In this disclosure, the exemplary construction case where the first party (the party incurring the debt) is a builder (contractor) involved in the financing of a building project and the second party (the party being paid) is a subcontractor working for the first party is purely a preferred embodiment. This construction embodiment should not be taken as limiting on the scope of the invention as the systems and methods can be applied to other construction related activities as well as to other contractor-type of arrangements and other types of transactions whereby borrowed funds are used to finance a transaction or other activity.

The exemplary cases here discussed provide that the first party receive the incentive in the form of or directly linked to “reward points” for utilizing the incentive lending instrument. “Reward points” is used as a general term to indicate any type of incentive where the value of the incentive is in direct correlation to the number of reward points received and is directly related to the number of dollars borrowed through an incentive lending instrument (such as a credit card). The incentive may be any type of incentive offered on any type of credit card known now or later discovered. Alternatively, the incentive may be provided by any other type of lending instrument other than a credit card. A credit card is just an exemplary embodiment. Reward points will generally be redeemable for discounts on later purchases or for merchandise, may be used as a refund against certain purchases, may be redeemable for cash, or may be airline miles or other “counters” used by other secondary reward programs to obtain free services, merchandise, or discounts through those systems.

Another term used herein is “delay period” or “payment window.” A delay period or payment window is the period of time granted by a lending institution owed a debt on a lending instrument during which the party owed the debt can be paid by the borrower without the borrower incurring an interest charge or other time-based cost on the debt. This may be referred to as a period “same as cash.” If the debt is repaid in the window, no interest is paid so it is the same as if the funds originally used had been cash in hand. In this period, so long as a complete payment is made before its expiration, the buyer (first party) is not charged any interest (it may or may not accumulate during the period) by the lending institution. While the embodiments discussed below utilize the payment window of the incentive lending instrument, one of ordinary skill in the art would understand that with sufficiently quick money transfer, the system may be implemented using an incentive lending instrument not having a payment window.

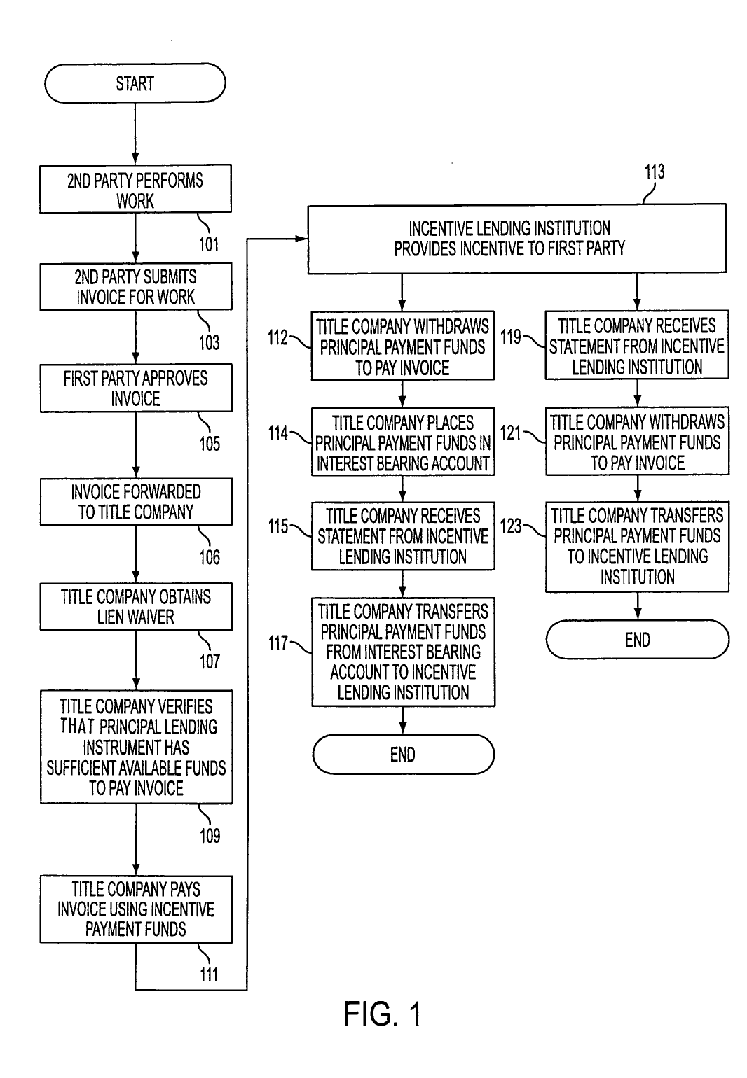

FIGS. 1 through 6 provide for diagrams of embodiments of systems and methods whereby lending instrument (generally one which is unsecured) having an incorporated incentive program can be inserted into a transaction based on a secured lending instrument or other financial instrument to allow a party to obtain the incentives without sacrificing the preferred terms (generally the lower interest rate) on a second instrument. The FIGS. presume that there is a party relationship previously established between a first party and a second party whereby the first party needs to pay the second party.

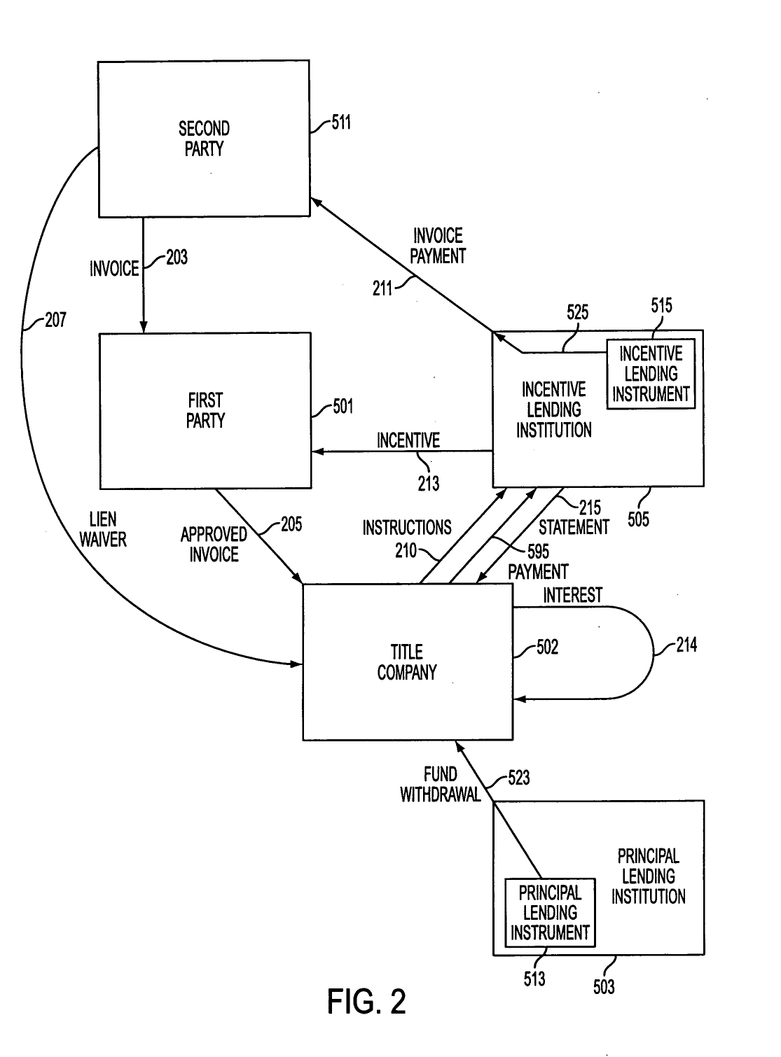

The systems and methods will generally include the interaction and activity of multiple parties or “entities.” The multiple entities shown in FIGS. 2 through 5 are generally described here for clarity prior to the detailed description of the systems and methods shown in the FIGS. The first party (501) is the borrower of funds as authorized under the lending instruments, such as for the building activity in the construction embodiment. The authorized borrowing includes borrowing under both the principal lending instrument (513) and the incentive lending instrument (515). In the construction embodiment, the first party (501) is a contractor working for a buyer (not shown) who is purchasing the contractor's services to complete a building project. In the FIGS., the buyer is not shown as their interaction with the contractor is not relevant to that embodiment of the invention as the buyer will simply purchase the resultant construction and their purchase does not effect the cash flow during construction. Rather, the first party (501) uses the principal payment funds (523) from the principal lending instrument (513) to finance the building project during construction.

The first party (501) will work with at least one and usually a plurality of second parties (511) which in the construction embodiment are construction subcontractors. A second party (511) will be paid by the first party (501) for services or goods tendered to the first party (501) to help complete the building activities of the first party (501).

The principal lending institution (503) will generally be a bank or lender providing the principal lending instrument (513) through which the principal payment funds (523) are transferred to the first party (501). The principal payment funds (523) are generally authorized withdrawals on a line of credit or other similar lending instruments (the principal lending instrument (513)), which authorize withdrawals up to a certain amount intended to be used by the first party (501) to finance the construction project and to pay the second party (511) for their help therein. The principal lending institution (503) will generally not offer any incentives for utilizing the principal payment funds (523) from the principal lending instrument (513) but may in an alternative embodiment. Generally, repayment of the principal payment funds (523) will be secured by the result of the work of the first party (501) and will generally be of a sufficiently high level that the first party (501) could not obtain the funds without such security in place. The principal payment funds (523) will be subject to a first interest rate (not shown) for their repayment. In an alternative embodiment, the principal lending instrument (513) may be replaced by available funds in a savings, checking, or similar deposit account owned by the first party (501). In this embodiment, there is no principal lending instrument (513), but instead a principal source of funds (namely the available funds) which replaces the principal lending instrument as the source of principal payment funds (523). In a still further embodiment the principal payment instrument (513) and a principal source of funds may be used together to provide the principle payment funds (523).

There is also included an incentive lending institution (505). The incentive lending institution (505) will generally offer an incentive for withdrawing funds (incentive payment funds (525)) from an unsecured loan instrument (the incentive lending instrument (515)) they provide to the user (first party (501)). The incentive lending institution (505) will generally be the offer or of a credit card account or similar instrument. That is, it is a lender providing credit using such systems as American Express, Visa, MasterCard, Diner's Club, or Discover/Novus, whether or not a physical “card” exists or is simply referenced as an account number or account. The incentive lending instrument (515) may also be associated with a particular manufacturer or supplier of goods. Funds provided from the incentive lending instrument (515) will generally be monies provided against a specific credit line predetermined according to the creditworthiness of the owner of the account, which will generally be the first party (501). Generally, and in absence of the discussed systems and methods, repayment of the incentive payment funds (525) will be unsecured and the incentive lending instrument (515) will have a much lower preauthorized withdrawal level compared to the principal lending instrument (513) due, at least in part, to its unsecured nature.

The incentive lending institution (505) will generally have a payment window after withdrawal (often approximately 30 days) during which time if the incentive payment finds (525) advanced to the user (the first party (501)) are repaid there is no interest charged on the loan but the incentives earned are still retained by the first party (501). The incentive lending institution (505) may charge a fee to a second party (511) accepting the incentive payment funds (525) for the second party (511) to be able to accept incentive payment funds (525) as payment for goods and services. Further, the incentive lending institution (505) would generally charge a second interest rate (not shown) on funds which are outstanding after the close of the payment window, however, this second interest rate will generally not be charged in these systems and methods as there will be no funds outstanding after the close of the payment window. This second interest rate will generally be significantly higher than the first interest rate to provide for high profit even without security on repayment. The incentive lending institution (505) may also charge an annual fee to the first party (501) to have access to the incentive payment funds (525).

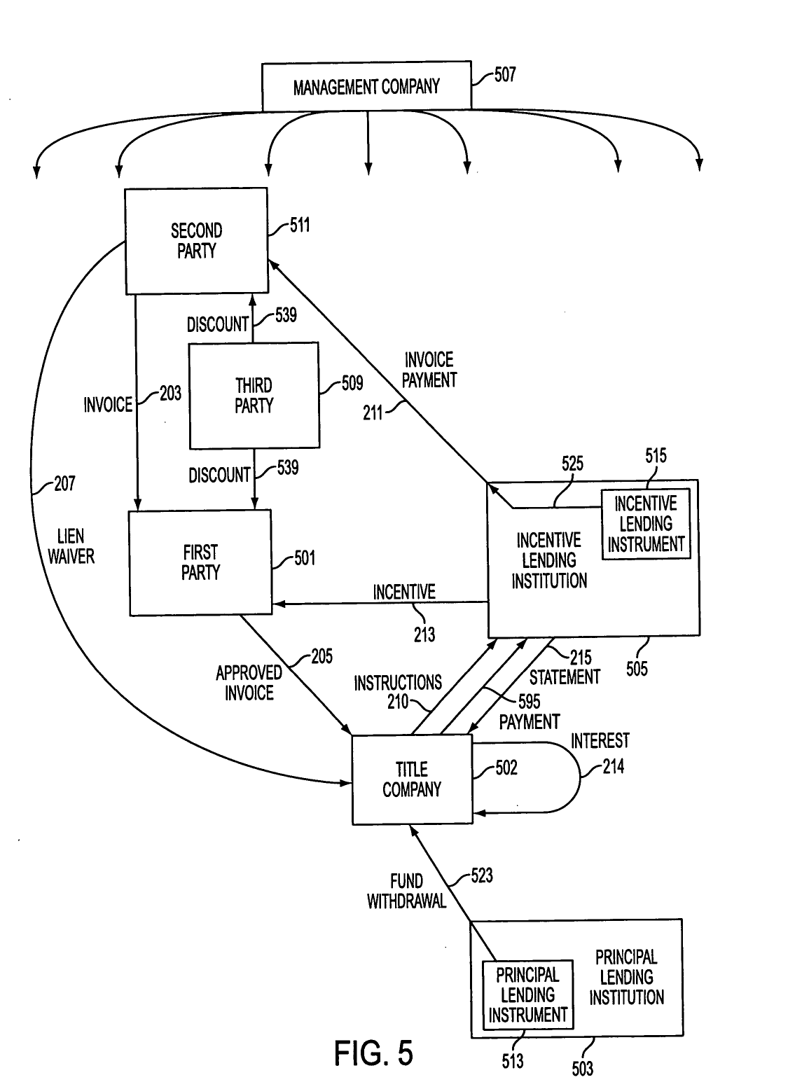

There is also shown in the embodiment of FIG. 5 a management company (507) which serves to control and coordinate the operation of the system and method. In particular, the management company (507) can act to help the other involved parties to locate each other, to complete transactions smoothly, and may also provide services to make the system exclusive to those who have joined. In the depicted embodiments, the systems and methods also include a third party provider (509) which provides goods and services (e.g. materials such as lumber, nails, tools, paint, or concrete) to the first party (501) or second party (511).

In some of the FIGS., there is also shown a title company (502). The title company (502) will generally act as a third party intermediary between the first party (501), principal lending institution (503), and second party (511). Further, the title company (502) may be able to provide services to the parties (501) and (511), principal lending institution (503), or buyer outside the bounds of the transactions discussed. Further, while the term “title company” refers to a particular type of institution, in an embodiment of the invention it should be clear that a different type of third party may act as intermediary between the first party (501) and second party (511). Therefore, the use of the term title company (502) is intended to simply be representative of such a third party intermediary.

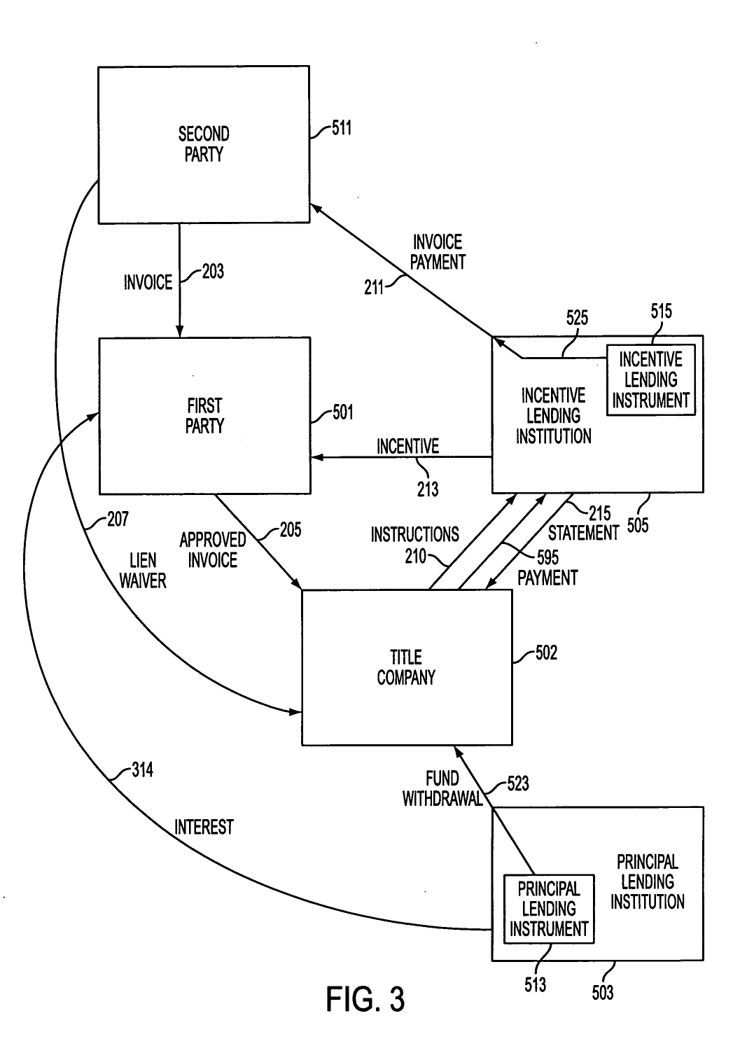

FIGS. 1 through 3 provide a general overview of money and instrument flow in two embodiments of the system. FIG. 1 provides a flowchart of steps involved in the financial transaction while FIGS. 2 and 3 illustrate the flow of funds, invoices, and other documents related to the transactions between the entities. The figures will be discussed simultaneously.

In step (101) the second party (511) performs work or provides goods for the project for which they need to be paid by the first party (501). In step (103), the second party (511) submits an invoice, bill or other account due instrument (203) to the first party (501). The invoice (203) will generally have a delay period for payment built in, or it may be accepted that a delay period will result from common practice of review and proving of bills prior to paying the invoice (203), but this is by no means necessary.

In step (105), the first party (501) approves the invoice (203) indicating that the second party (511) should be paid. This creates the approved invoice (205). The first party (501) then forwards the approved invoice (205) to the title company (502) in step (106). In a preferred embodiment, this transaction occurs electronically through computer transmission, but this is by no means required. Upon receipt by the title company (502) of the approved invoice (205), the title company (502) obtains a lien wavier (207) from the second party (511) in step (107). Alternatively, such lien waiver may have already been transferred to the title company (502) by the second party (511) prior to the approved invoice (205) being received. Step (107) may not be necessary in all cases depending on laws in various jurisdictions. The lien waiver (207) is generally a release by the second party (511) of any construction liens or related legal security on the result of the work performed by the second party (511) and is particularly desirable when the first party (501) is a construction contractor and the second party (511) is a construction subcontractor. In step (109), the title company (502) verifies that the principal lending instrument (513) includes sufficient principal payment funds (523) to authorize the withdrawal of funds in an amount sufficient to pay the approved invoice (205) if this step has not been performed previously.

Step (109) is a preferred step, but is by no means required. It is preferred because it provides that sufficient funds are available from the principal payment instrument (513) to pay the approved invoice (205) and therefore, payment from the incentive payment funds (525) can be supported by the funds available in the principal lending instrument (513). There can effectively be no risk to the incentive lending institution (505), which is otherwise unsecured, when a step such as step (109) is used.

Step (109) is particularly valuable as it allows for a particular embodiment of the invention to provide for a dramatic increase in the amount of funds which can be borrowed from the incentive lending institution (505). All loan instruments are generally limited by the security or safety of the lender. In particular, credit cards or other unsecured credit generally impose credit limits on the amount of money which may be borrowed. This is generally true even if the borrower on the loan is very wealthy (the limit is generally just higher). In secured loans, amounts are generally limited by the value of the security interest provided.

With the inclusion of step (109) it should be apparent that a limit on the incentive lending instrument (515) is unneeded. In particular, because the title company (502) has affirmed that the money is available to pay off the loan (and, in fact, may have the money set aside to pay the loan), the incentive lending instrument (515) can be used to pay any value, without any risk being incurred by the incentive lending institution (505). This is different from any other type of lending. In effect, the incentive lending institution (505) can provide a loan without risk, as repayment is assured by the existence of money to pay back the loan (and already earmarked to pay back the loan), regardless of the loan amount. This is of critical importance to the operation of an embodiment of the invention as it allows for existing unsecured lending instruments (such as credit cards) to be used as the incentive lending instrument (515) without having to deal with any associated credit limits which would normally exist at a predetermined level for such an instrument and therefore allowing a dramatic increase in the number of reward points that can be earned. In particular, the amount paid by the incentive lending institution (505) may be in an amount greater than a predetermined “limit” (namely the associated unsecured credit limit) imposed on the incentive lending instrument (515) because the “unsecured” credit is effectively secured through use of an embodiment of the system.

In step (111) the title company (502) (or alternately the first party (501)) sends instructions (210) to the incentive lending institution (505) to pay the second party (511) the invoice payment (211) which is the funds to pay the approved invoice (205). The invoice payment (211) comprises incentive payment finds (525) withdrawn from the incentive lending instrument (515) to pay the second party (511). The transfer of the funds will generally occur through one of two pathways.

In the depicted embodiment, the funds are transferred directly from the incentive lending institution (505) to the second party (511). This allows for a more traditional style of transaction. In an alternative embodiment, instead of this direct transfer, the incentive lending institution may provide the title company (502) either with the funds, or with a code, such as, but not limited to, an electronic password, and the title company passes the code or funds to the second party (511). If a code is used, the code may then be provided by the second party (511) to the incentive lending institution (505), such as through an Internet or intranet access point. Entry of the code may then trigger an event such as direct deposit of funds into a prespecified account of the second party (511) or, if the second party (511) also has a lending instrument through the incentive lending institution (505), the funds may be credited against any outstanding balances on that account.

In an embodiment, the amount of the incentive payment funds (525) withdrawn may exceed the amount pre-authorized for unsecured withdrawal from the incentive lending instrument (515). This follows the above description of assurance of repayment and may occur either because the individual withdrawal is higher than the limit or because the individual withdrawal in conjunction with debt already assigned to the incentive lending instrument (515) and not previously paid back is over the limit. In this embodiment, this is an acceptable loan on the part of the incentive lending institution (505) as the incentive lending institution (505) may be assured repayment of the loan by the title company (502) as the title company (502) may have already obtained the amount of money to cover the entire transaction or knows it is available from step (109). Further, the loan may be acceptable because even without such a guarantee, the incentive lending institution (505) may know that funds will be repaid simply through participation in this payment system.

When the incentive lending instrument (515) is “charged” for the incentive payment funds (525) transferred to the second party (511), step (113) applies an incentive (213) to the first party's (501) account from this use of the incentive lending instrument (515) as a source of lending. The size of the incentive (213) (the number of reward points) applied to the first party's (501) account will generally be proportional to the size of the incentive payment funds (525) used but need not be in an alternative embodiment. The first party (501) may then use the incentive (213) as they see fit in a manner allowed by the incentive program. In an embodiment, step (113) may require the intervention of an administrator or other agent of the first party (501) to provide for proper allocation of the incentive or selection of rewards.

After step (113), the embodiments of FIGS. 2 and 3 separate as different embodiments utilize different orders of events. In an interest payment embodiment (shown in FIG. 2), the title company (502) will withdraw principal payment funds (523) from the principal lending instrument (513) (or principal source of funds) equal to the amount of the approved invoice (205) which is also identical to the amount of the incentive payment funds (525) previously withdrawn. This step (112) will generally take place in close proximity to or even before step (111) depending on the embodiment. The title company (502) in step (114) will then place the principal payment funds (523) in an interest bearing account paying interest to the title company (502). This account is preferably a legal instrument (such as a trust account) which provides that the principal payment funds (523) withdrawn will be paid to the incentive lending institution (505) regardless of what may occur to the title company (505). For instance, the principal payment funds (523) are assured to be provided to the incentive lending institution (505) even in the event of title company (502) being insolvent or declaring bankruptcy. This legal instrument preferably both earns interest (214) for the title company (502) and serves as assurance on the incentive payment funds (525) withdrawn by the title company (502) as the invoice payment (211).

The title company (502) will receive a statement (215) in step (115) from the incentive lending institution (505) (it may pass through the first party (501) in an embodiment) indicating when the delay period for repaying the amount of the incentive payment funds (525) to the incentive lending instrument (515) expires. At some time during the delay period, the title company (502) will transfer, in step (117), the principal payment funds (523) from their account to the incentive lending institution (505) as payment (595). As was discussed above, as the principal payment funds (523) withdrawn and the debt entered for the withdrawal for the incentive payment funds (525) are both of equal amount, the statement (215) is paid off in step (117). The interest (214) will generally be kept by the title company (502) as payment for their role in the payment system. However, in an alternative embodiment, the interest (214) may be provided to a different party as discussed later. Once the incentive lending institution (505) has been provided the principal payment funds (523), the transaction is complete.

Once the transaction is complete, it should be clear that the second party (511) has been paid, the incentive lending institution (505) has had a debit and credit of equal magnitude returning them to their starting position. The title company (502) does not have any remaining balance (other than interest (214) as discussed later) and the first party (501) owes the principal lending institution (503) the amount of the second party's (511) invoice (203). Except for the incentive reward points and the interest (214) earned, this is the same net result as would be obtained by a system which did not have the incentive lending institution (505) involved. In particular, the first party (501) incurs no additional interest expense as the resultant borrowing is from the principal lending institution (503) at the transaction conclusion, but the first party (501) has additionally acquired the incentive (213).

It should also be clear that in a preferred embodiment, the completion of the transaction described herein and shown in FIG. 1 is merely one of a series of transactions (multiple repetitions of FIG. 1) occurring as the building is constructed. In this generally periodic flow of transactions, each transaction operates in a generally similar fashion and allows for a relatively time-regulated pattern of borrowing. Further, it should be apparent that in the generalized arrangement where there are multiple invoices being paid, different invoice payments may be at different steps of FIG. 1 simultaneously.

As should be clear from the above described embodiment, a benefit over the prior art is obtained by the insertion of the incentive lending institution (505) into the transaction. Because of the delay period, no additional cost is incurred by either the first party (501) or title company (502) by having the second party (511) paid using the incentive payment funds (525), the debit entry of which is then reimbursed with the principal payment funds (523), as opposed to simply providing the principal payment funds (523) directly to the second party (511). At the same time, the first party (501) has obtained the incentive which has been credited to their account. The incentive may have cash value or may be able to be exchanged for services or merchandise useful to the first party (501).

In the alternate embodiment shown in the alternate arm of FIG. 1 and in FIG. 3, the system operates in generally the same manner; however, the steps are performed in a different order to allow for redistribution of interest. In this embodiment, which illustrates a fee payment scheme, the title company (502) does not withdraw the principal payment funds (523) from the principal lending instrument (513) (or principal source of funds) until the statement (215) is due. Again, allocated funds may be controlled by a legal instrument to provide payment to the incentive lending institution (505) even if something happens to the trust company (502) or principal lending institution (503). In this embodiment, the statement (215) is first received from the incentive lending institution (505) in step (119). The principal payment funds (523) remain in the principal lending institution (503) until the delay period has been at least partially used. Therefore, the funds either earn interest (314) in this account or a lending interest charge is not applied as the funds have not yet been borrowed. As economically these transactions both result in money being added to the account (either as a payment, or as the failure to incur a cost) this discussion will refer to both of these as having a net gain, that gain being called interest (314). In step (121), the principal payment funds (523) are withdrawn at or towards the end of the delay period and the incentive lending institution (505) is reimbursed relatively quickly thereafter by payment (595) in step (123) for providing the incentive payment funds (525). The transaction is again complete.

As should be seen in this transaction, the title company (502) and incentive lending institution (505) may both be essentially secured in this embodiment as well. In particular, as the title company (502) can monitor the amount of available funds in the principal lending instrument (513), they can also verify that funds are available prior to authorizing payment by the incentive lending institution (505) and may place legal control on these funds. Again, the parties are in the same situation and result as in the first described embodiment at the completion. However, in this case the interest (314) has been distributed to the first party (501) instead of interest (214) being distributed to the title company (502). An advantage of this embodiment is that the first party (501) is able to avoid interest charges on the principal payment funds (523) during the delay period of the incentive lending institution (505). This may be particularly beneficial where the interest (314) is actually a saved charge. Due to the necessity of financial institutions to make money (and protect themselves from losses), the interest rate to borrow money is regularly higher than the interest rate to save the same amount of money. That is, it will cost more to borrow $X for a period of time than $X will make in a secure interest bearing account in the same amount of time. Therefore, the second discussed embodiment will generally result in a net increase in money in the system over the first embodiment.

The interest (314) may then be split amongst the title company (502) and first party (501) to provide both with a benefit. This may be the payment method for the first party (501) to pay for the services of the title company (502). In still another embodiment, the interest (314) can be distributed amongst the parties as discussed later in this disclosure. In addition to the overall net benefit to the parties of the second embodiment, this embodiment would generally be preferred in states or countries where local laws would prevent the title company (502) from earning and/or keeping the interest (214). This embodiment may also be used as a framework when the incentive lending institution (505) offers no payment window with the funds simply being withdrawn from the principal lending instrument (513) and paid to the incentive lending instrument (515) relatively simultaneously with the funds being withdrawn from the incentive lending instrument (515). In this situation, the need for a payment window is eliminated, but generally the interest (314) is also.

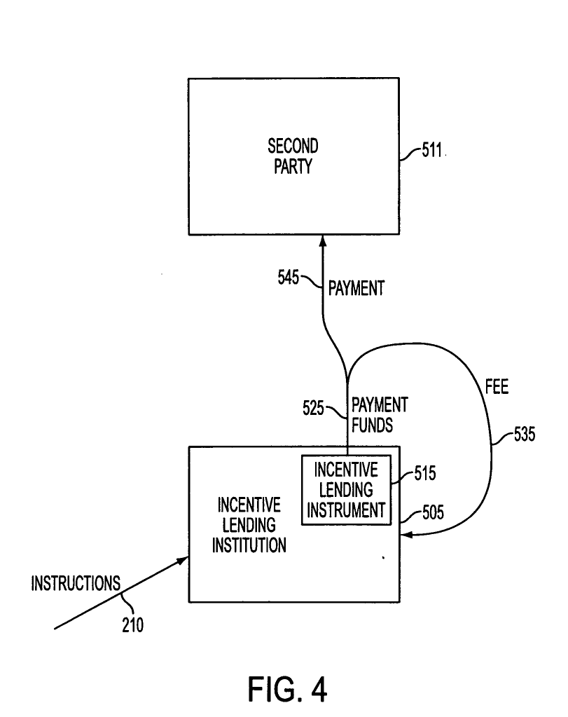

While in the above embodiments the incentive is obtained with little or no cost to the first party (501) or title company (502), one of ordinary skill in the art would understand that a cost may be imposed on either party to allow the incentive to be earned. This may be to offset some of the second party's (511) cost (discussed later) or may be desirable depending on the value of the incentive to the first party (501). In still a further embodiment, the cost of the incentive may be passed on to the second party (511). This is discussed in conjunction with FIG. 4 below.

Now that the basics of the transaction have been shown, the methods for providing benefits to various entities in an embodiment can be illustrated as can the distribution of costs. The first entity to consider is the first party (501). In the embodiment of FIG. 3, the first party (501) clearly saves interest costs on the source of funds by utilizing the delay period. In both embodiments, the first party (501) also ends up with the reward points which have been deposited to its account. As many costs involved in construction can be quite significant, the value of these incentives may be sufficiently high to justify the program on its own. Further, the first party (501) is able to obtain incentives on much more money than the incentive lending institution (505) would normally let it borrow because of the built in security feature of the title company (502) verifying the existence of funds prior to withdrawing from the incentive lending institution (505) which effectively secures the incentive lending institution's (505) unsecured loan.

The first party (501) will generally have to provide some form of value to the title company (502) for them to accept the arrangement. This may be the interest (214) or some portion of the interest (314), may be a fee paid to the title company (502), or may be less tangible value such as by referring other business to the title company (502) related generally to the work of the first party (501) but not necessarily to this specific transaction (such as the title work for the resulting construction in the construction embodiment).

The title company (502) can benefit from this transaction from any of the above referenced payments from the first party (501). Further, they can benefit from increased business in performing this type of work as their services, by providing the incentive to the first party (501), are more desirable than similar entities whose use does not provide the incentive. They may also collect a fee from any entity involved in the system.

The principal lending institution (503) will gain the benefit from providing the principal lending funds (523) in the same way they would in a system without inclusion of the incentive lending institution (505). They may also or alternatively be provided with a fee for participating in the system or an increase in business by being able to participate in this type of system. They can also gain the increase in security provided by the inclusion of title company (502).

The incentive lending institution (505) will generally be able to get a fee for handling the initial payment. This may be an annual or other membership fee charged to the first party (501). In another embodiment, the transactions between the second party (511) and incentive lending institution (505) are used to provide the incentive lending institution (505) with a payment. An embodiment of this arrangement is shown in FIG. 4 which provides a little more detail to an embodiment of FIG. 2.

In the first step (401) of FIG. 4, the incentive lending institution (505) receives the instructions (210) to pay the second party (511) the amount of the approved invoice (205). Once the instruction is received, in step (403), the incentive lending institution (505) prepares incentive payment funds (525) for transfer. They then transfer a number of reward points to the account holder (the debtor) of the incentive lending instrument (515) which in this case is the first party (501). They then withdraw the incentive payment finds (525) in the amount of the approved invoice (205) from the account and enter a debit in the account for that amount. They take the incentive payment funds (525) and subtract from it a fee (535). This fee (535) may be a fixed amount regardless of the size of the transaction, but will generally be a percentage of the amount of incentive payment funds (525) to be provided. The incentive lending institution (505) keeps the fee (535) and transfers the remainder (545) to the second party (511) in step (405). Therefore, the funds provided by the incentive lending institution (505) to the second party (511) are actually decreased by the fee (535) effectively resulting in the second party (511) paying a fee for the service.

Generally, the fee for the transaction will be the way that the incentive lending institution (505) is paid for their roll in the transaction. As the incentive lending institution (505) will generally be in the business of fulfilling payment instructions for a fee to the entity paid, the incentive lending institution (505) will generally treat this transaction in the same manner as any other “charge” against an account owner's account.

As should be clear from the above description, the amount the second party (511) is paid has been reduced by the amount of the fee (535). Therefore, in a strict dollar sense, the second party (511) is paying a cost of inclusion of the incentive lending institution (505). The second party (511) will, however, generally benefit in other ways. The first and most prominent benefit to the second party (511) is that this type of organized system will generally result in them being paid for their work much quicker than would be expected under a normal payment scheme (discussed in the background section). Because the first party has available credit with the incentive lending institution (505) accessible by the title company (502) immediately and because there is not a significant benefit in delaying payment to the second party (511), the title company (502) can generally process the transaction quicker and more effectively than the first party (501) can or will under the prior art system. Faster payment can result in interest earned by the second party (511) on the payment for the difference in time which helps offset the fees charged. Further, receiving payment faster can allow the second party (511) to pay off their debts quicker, which can prevent them from having to incur interest charges on items they purchased on credit to perform the work of the invoice (203).

The time of payment is an important issue to construction subcontractors and makes this scheme particularly relevant in a construction embodiment. Currently, a subcontractor will generally not be paid for their work until a significant amount of time has passed after they complete the work, and therefore, the subcontractor is forced to use a credit scheme themselves to pay bills as they await payment. In particular, a subcontractor will often be forced to purchase supplies for the job long before they will be paid for the job. Therefore, the subcontractor will need to have access to a form of credit themselves (often a credit card) to purchase the items they need to perform the job. If payment takes too long, the subcontractor may end up paying significant interest on this credit that they cannot necessarily recoup from the contractor as the bill they have provided is already of a fixed amount. A faster payment scheme can eliminate or reduce this cost, resulting in a reduction of the “fee” paid.

Further, because the second party (511) will accept payment from the incentive lending institution (505) and pay the fee, the services of second party (511) are generally more desirable to the first party (501) than other parties who perform similar work but cannot be paid using the incentive lending institution (505) because the first party (501) will earn the incentive using this second party (511). This increases the demand for the second party's (511) services which should increase their overall work.

In yet another embodiment, the first party (501) can also provide benefits to the second party (511) by providing the second party (511) with some of the first party's (501) gains from the system. In an embodiment, the first party (501) may provide the second party (511) with a percentage of the rewards points earned which the second party (511) can use for their own personal benefit. Alternatively, the first party (501) may provide merchandise or services to the second party (511) that the first party (501) obtained with the reward points. In still another embodiment, the first party (501) may pay some or all of the fee (535) charged to the second party by the incentive lending institution (505) such as from the interest (314).

While the sections above have discussed the inclusion of the incentive lending institution (505) into the transaction to provide for a payment system where incentives are earned, there may be the inclusion of other entities into the system which can further improve the operation and benefits of the system in an embodiment. An embodiment including two additional entities is shown in FIG. 5.

In the embodiment of FIG. 5, the system includes and is administrated by a management company (507). The management company (507) serves to orchestrate connection between the various entities and ensure that the pathways operate smoothly. They can regulate the various transactions, or may serve as any of the entities in the embodiment of FIGS. 2 or 3. The management company (507) will generally charge fees to the other entities to be part of the system in exchange for providing access to the other entities in the system which the individual entities may not have prior access to. Further, the management company (507) may also retain the power to exclude various entities from participating in the system such as by regulating membership. Control or member status could be a means to ensure quality and timely action by the member entities and provide for smooth functioning of the system for all entities.

The management company (507) can also orchestrate improvements to the system due to enlarging participation in the system. In particular, in the embodiment of the FIGS. there is only a single entity of each type shown. The management company (507) may be able to bring numerous entities of each entity type into the same system. As this occurs, the benefits to each individual entity increase as the total amount of work they are doing increases. This can in turn lead to a decrease in costs or fees to members.

Further, the management company (507) can work with other entities indirectly involved in the transaction. In particular, the management company (507) can direct buyers into the system to allow for more work to be available to all members. Further, the management company (507) can negotiate discounts (239) at third party providers (509) which supply the first party (501) and/or second party (511) with necessary goods or services (e.g. materials such as lumber, nails, tools, paint or concrete). In the construction embodiment, these third party providers (509) may be suppliers to construction contractors or subcontractors such as lumberyards or home improvement warehouses where raw materials of construction are purchased. The discounts will both provide a benefit to the parties (501) and (511) who will be able to pocket the savings provided, and can benefit the third party providers (509) by increasing their total business. In addition to discounts, the management company (507) may be able to negotiate improved payment terms for credit provided by the third party providers (509) as well, based on membership in the system. In a still further embodiment, the incentive (213) earned may be used to pay for or discount products at the third party provider (509).

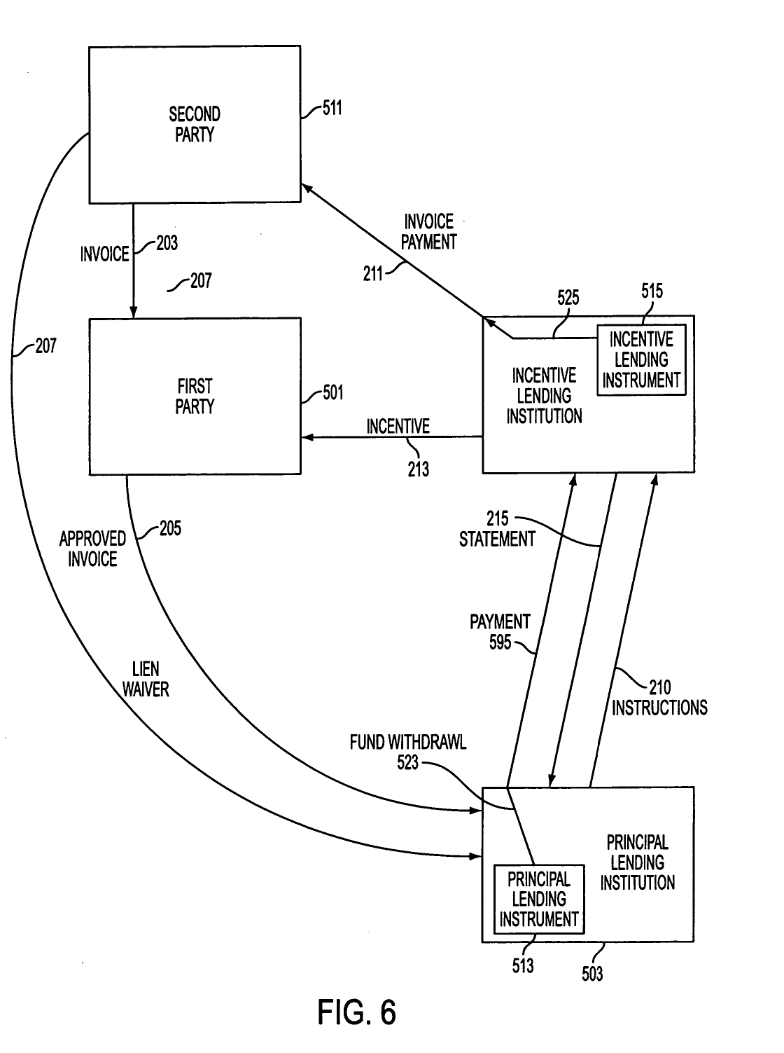

FIG. 6 provides an indication of a still further embodiment of the invention. In this embodiment, the title company (502) is eliminated from the scheme with the principal lending institution (503) acting as the title company (502) and performing all the actions previously performed by the title company. In this embodiment, the principal lending institution (503) fulfills the role of the title company (502) and can assure the payment of the incentive lending institution (505) in the same or similar manner.

While the above embodiments discussed above are principally directed to the use of the system and a method whereby the first party (501) and second party (511) are respectively a contractor/and subcontractor in the construction field with the principal lending institution (503) providing a secured line of credit to fund the construction and the incentive lending institution (505) being an unsecured credit card company, one of ordinary skill in the art would understand how the invention could be used in other similar relationships with any two parties (such as, but not limited to, a buyer/seller or a principal/agent relationship) and any two financial instruments whereby one offers incentives to borrow and the other provides improved terms.

Further, the systems and methods can be used for other types of projects outside of construction such as, but not limited to, the manufacturing of consumer or commercial goods, the purchase of items on long term credit such as property, vehicles, or machinery, the advance purchase of long term service agreements, commodities, or materials, or any situation where a purchase price exceeds available unsecured incentive lending credit without the inclusion of such a system. Additionally, any of the entities detailed in the FIGS. could involve overlap with other entities or otherwise be in a legal relationship with other entities sop as to perform actions herein attributed to those other entities.

Further, while the discussion above focuses on the principal lending instrument (513) being used in the construction context, the system and method may be used in any case where the principal lending instrument (513) is authorized for another purpose, particularly if the size of the lending instrument would be such that it would not normally be granted to the first entity without a security interest. In this way, the system may be used to gain the incentives for other transactions in commercial and individual contexts. For instance, the system may be used to provide incentives for the purchase of heavy equipment; factories, office buildings, residences, or other real estate; manufacturing equipment; vehicles; or other expensive items.

Further, the systems and methods can be used in other industries where large projects are paid for. For instance, the systems and methods may be used to earn incentives on the payments for facilities, materials, salaries or costs of cinematic, television, theatrical, or musical productions. It may also be used to earn incentives for the recording of musical or similar works. In a still further embodiment, it may be used to purchase aircraft or infrastructure or to finance research and development schemes.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A method for a first party to earn an incentive from borrowing, the method comprising:
having two sources of borrowed funds, a principal lending instrument having a first level of funds available for secured borrowing and an incentive lending instrument having a second level of funds available for unsecured borrowing, the first level being greater than the second level, and said incentive lending instrument providing an incentive for borrowing;
borrowing funds in a first amount from said incentive lending instrument incurring a first debt to said incentive lending instrument;
accruing said incentive from said incentive lending instrument;
paying said second party with at least a portion of said funds borrowed from said incentive lending instrument;
borrowing funds in said first amount from said principal lending instrument incurring a second debt to said principal lending instrument; and
crediting said incentive lending instrument with said funds borrowed from said principal lending instrument to eliminate said first debt prior to being charged interest on said first debt.

2. The method of claim 1 wherein said second debt incurs interest charges.

3. The method of claim 2 wherein interest charged on said first debt would be higher than said interest charged on said second debt if said first debt was not credited prior to said interest being charged.

4. The method of claim 1 wherein said first party is a contractor in the construction field and said second party is a subcontractor is the construction field.

5. The method of claim 1 wherein said incentive lending instrument is a credit card agreement providing for available credit on a credit card.

6. The method of claim 5 wherein said credit card consists of one of the following credit cards: American Express, MasterCard, Visa, Diner's Club, Discover, Novus.

7. The method of claim 1 wherein said principal lending instrument provides for a line of credit.

8. The method of claim 7 wherein said line of credit is a construction loan.

9. The method of claim 7 wherein said line of credit is provided by a bank.

10. The method of claim 1 wherein said incentive lending instrument includes a payment window from the time borrowing occurs until interest is charged if said first debt remains unpaid.

11. The method of claim 1 wherein said first debt exceeds said second level of funds.

12. The method of claim 11 wherein said first debt is allowed from said incentive lending instrument because said first debt is assured by said first level of funds in said principal lending instrument.

13. The method of claim 1 wherein said first debt and said second debt are of equal value.

14. The method of claim 1 further comprising the step of: providing a management company to coordinate the relationships among other entities involved in the system.

15. The method of claim 14 further comprising in said step of: having said management company limit who may participate in the system.

16. The method of claim 14 further comprising the step of: allowing said management company to provide benefits to entities participating in said method.

17. The method of claim 16 wherein in the step of allowing, said management company negotiates discounts with a third party provider for the benefit of at least one of said first party and said second party.

18. The method of claim 1 further comprising the step of: providing a title company which processes the transactions in both said steps of borrowing.

19. The method of claim 18 wherein said title company confirms that said principal lending instrument includes available credit for said first amount prior to said step of borrowing funds in said first amount from said incentive lending instrument.

20. The method of claim 18 wherein said title company earns interest on said first amount borrowed from said principal lending institution prior to said step of crediting.

21. The method of claim 1 wherein said at least a portion of said funds borrowed from said incentive lending instrument comprises said first amount less a fee.

22. The method of claim 1 wherein said first party provides at least a portion of said incentive to said second party.

23. The method of claim 1 wherein said incentive comprises a number of reward points determined based on said first amount.

24. The method of claim 1 wherein the method is repeatedly performed during a predetermined period of time.

25. The method of claim 24 wherein said predetermined period of time corresponds to the time it takes to complete a construction project.

26. A system for allowing a first party to earn an incentive from borrowing, the system comprising:
a first party;
a second party who is to be paid by said first party;
a principal lending instrument having a first level of funds available for secured borrowing; and
an incentive lending instrument having a second level of funds available for unsecured borrowing, the first level being greater than the second level, and said incentive lending instrument providing incentives for borrowing;
wherein funds are borrowed in a first amount from said incentive lending instrument incurring a first debt to said incentive lending instrument;
wherein said incentives are accrued to said first party from said incentive lending instrument;
wherein said second party is paid with at least a portion of said funds borrowed from said incentive lending instrument;
wherein funds in said first amount are borrowed from said principal lending instrument incurring a second debt to said principal lending instrument; and
wherein said incentive lending instrument is credited with said funds borrowed from said principal lending instrument to eliminate said first debt prior to being charged interest on said first debt.

27. The system of claim 26 further comprising a title company through which said funds borrowed from said principal lending instrument pass.

28. The system of claim 26 wherein said first amount is greater than said second level and less than said first level.

29. A system for allowing a first party to earn an incentive from spending, the system comprising:
a first party;
a second party who is to be paid by said first party;
a principal source of funds having a first level of funds available and owned by the first party;
an incentive lending instrument having a second level of funds available for unsecured borrowing, the first level being greater than the second level, and said incentive lending instrument providing incentives for borrowing;
wherein funds are borrowed in a first amount from said incentive lending instrument incurring a first debt to said incentive lending instrument, said first amount being greater than said second level but less than said first level;
wherein a title company withdraws said first amount of funds from said principal source of funds and places said first amount of funds from said principal source of funds in a trust assuring the repayment of said incentive lending instrument;
wherein said incentives are accrued to said first party from said incentive lending instrument on said first amount;
wherein said second party is paid with at least a portion of said funds borrowed from said incentive lending instrument; and
wherein said incentive lending instrument is credited with said funds from said principal source of funds to eliminate said first debt prior to being charged interest on said first debt.
